(19) United States
(12) Patent Application Publication
(10) Pub. No.: US 2012/0193562 A1
(43) Pub. Date: Aug. 2, 2012

(54) STRUCTURE FOR REDUCING AXIAL LEAKAGE OF VALVE

(76) Inventors: Katsunori Takai, Tokyo (JP); Satoru Hasegawa, Tokyo (JP); Masayuki Yokoyama, Tokyo (JP)

(21) Appl. No.: 13/498,608

(22) PCT Filed: Feb. 18, 2010
(86) PCT No.: PCT/JP2010/001047

§ 371 Date: Mar. 28, 2012

(51) Int. Cl. F16K 41/00

(52) U.S. Cl. 251/214

(57) ABSTRACT

A plate 36 is press-fitted on the outer peripheral surface of a rod 32 to eliminate a gap between the rod 32 and the plate 36, and further the pressurization produced by the pressure of gas leaking from a gas passage 38 and the load of a washer 26 is caused to act on the rod 32 to thereby positively abut the plate 36 united with the rod 32 against a bush 35.

### TECHNICAL FIELD

The present invention relates to a structure for reducing the axial leakage in a fluid controlling valve such as an exhaust gas recirculation (EGR) valve.

### BACKGROUND ART

With the enhancement of exhaust gas regulations associated with recent environmental problems, in order to reduce the emissions from an engine, it has been requisite to reduce the axial leakage in a valve such as an EGR valve through which a high temperature gas is flown.

Conventionally, in a fluid controlling valve, in order to suppress the axial leakage where the fluid inside a fluid passage leaks through a gap between a housing or a bearing, bushing and a valve shaft, a shaft seal made of polytetrafluoroethylene (PTFE) or fluoroplastic or a labyrinth seal structure is provided in the gap. For example, in an axial leakage reducing structure disclosed in Patent Document 1, a labyrinth seal is provided around the outer periphery of a valve shaft on the side of the fluid passage of the bushing provided at a switching portion of the valve shaft from a fluid passage to a housing to thus form a zigzag fluid passage to thereby prevent fluid from easily flowing out from the fluid passage to the bushing, and also a lip seal made of PTFE is provided around the outer periphery of the valve shaft on the housing side to suppress the axial leakage from the bushing to the housing.

### Prior Art Documents

Patent Documents

Patent Document 1: JP-A-2007-32301

### SUMMARY OF THE INVENTION

However, since the high temperature gas flowing through an EGR valve reaches 200-800° C., and especially the high temperature gas flowing through a hot-side valve disposed immediately before an EGR cooler reaches as high as 800° C., it is difficult or impossible to use a conventional PTFE or fluoroplastic-based shaft seal due to the possibility of exceeding the heat resistant temperature thereof; thus, there is a problem such that it is difficult to suppress the amount of axial leakage.

For example, in the axial leakage reducing structure disclosed in Patent Document 1, since no labyrinth seal fills the gap between the bushing and the valve shaft, the high-temperature exhaust gas flowing through the fluid passage leaks from the gap to form a fluid passage at the labyrinth seal part. For this reason, it is expected that the lip seal mainly plays the role of suppressing the axial leakage; however, since the lip seal is made of PTFE, the lip seal cannot be employed in a valve such that a hot temperature gas of 200-800° C. flows therethrough, as mentioned above, which makes it impossible to reduce the amount of axial leakage.

Therefore, when the axial leakage reducing structure disclosed in Patent Document 1 is used for a fluid having a high temperature (200° C. or more), the labyrinth seal as is can be used; however, it is necessary that the material of the lip seal be changed from PTFE to metal or a high-temperature resistant material. However, in this case, it is expected that the friction between the lip seal and the valve shaft is increased to interfere with the operation of the valve shaft itself, and that the seal structure at the gap with the valve shaft cannot be established; thus, it is difficult to reduce the axial leakage thereof under the high temperature. In addition, the above structure is applicable to the fluid having a low temperature (lower than 200° C.), but has an inferior sealing function as compared with the shaft seal of PTFE. Note that the cost can be reduced.

The present invention is made to solve the above-mentioned problems, and an object of the invention is to provide an axial leakage reducing structure for reducing the axial leakage of a valve.

An axial leakage reducing structure of the invention includes: a housing in which a through hole communicating with a fluid passage provided inside is formed; a valve shaft inserted into the fluid passage through the through hole to be rotated about a central axis of rotation; a valve body to be rotated integrally with the valve shaft to open and close the fluid passage; a bushing section provided inside the through hole to pivotally support the valve shaft to be rotatable; and a shaft seal section press-fitted on the outer peripheral surface of the valve shaft to be rotated with abutting against the surface of the bushing section on the side of the fluid passage by the pressurization acting on the valve shaft.

According to the invention, since there is provided with the shaft seal section press-fitted on the outer peripheral surface of the valve shaft to be rotated with abutting against the surface of the bushing section on the side of the fluid passage by the pressurization acting on the valve shaft, the axial leakage reducing structure for a valve can be provided to reduce the axial leakage by eliminating the gap between the valve shaft and the shaft seal section and also the gap between the bushing section and the shaft seal section.

### BRIEF DESCRIPTION OF THE DRAWINGS

FIG. 1 is a sectional view showing an arrangement of an EGR valve in accordance with a first embodiment in the present invention.

FIG. 2 is an enlarged sectional view of an axial leakage reducing structure of the EGR valve shown in FIG. 1.

FIG. 3 is an enlarged sectional view around a plate of the EGR valve shown in FIG. 1.

### BEST MODE FOR CARRYING OUT THE INVENTION

In the following, embodiments for implementing the present invention will now be described with reference to the accompanying drawings to explain the present invention in more detail.

### First Embodiment

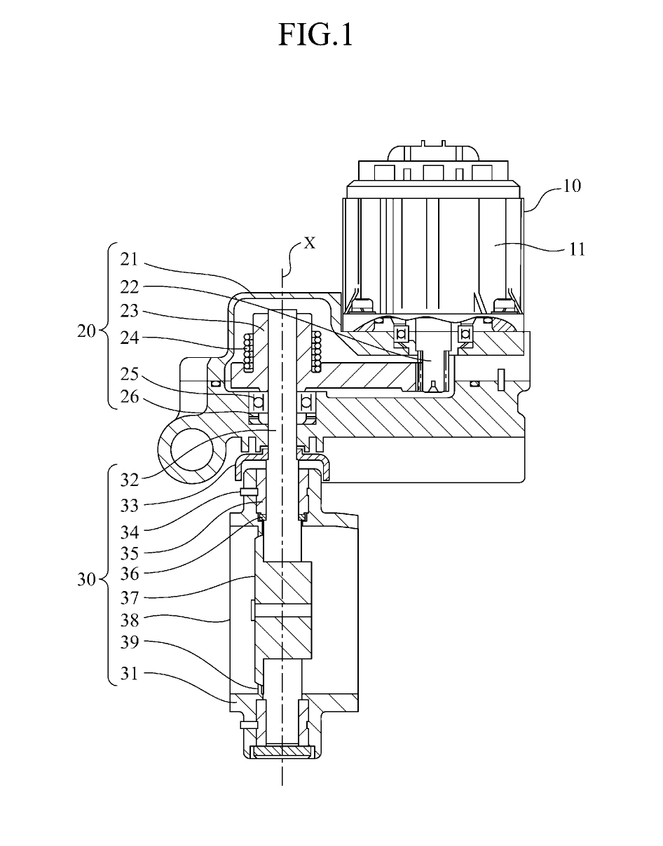

An EGR valve device shown in FIG. 1 is composed of an actuator section 10 for generating rotation driving force to open and close a valve; a gear section 20 for transmitting the driving force of the actuator section 10 to a rod (valve shaft) 32; and a valve section 30 interposed in a tube (not shown) to be flown through by a high-temperature exhaust gas to open and close a butterfly-valve-shaped valve (valve body) 37 to control the flow-through of the exhaust gas.

In the actuator section 10, a DC motor or the like is employed for a motor 11, and a pinion gear 22 located inside a gear section housing 21 is connected to one end of the driving shaft of the motor 11. When the motor 11 is driven, the pinion gear 22 and the gear 23 are rotated with meshing with each other to thereby transmit the driving force of the motor 11 to the rod 32. The rod 32 is pivotally supported to be rotatable by a bearing 25, and is rotated about the central axis of rotation X by the driving force to open the valve 37 fixed to the rod 32. The bearing 25 is upwardly pressurized in an axial direction by the load of a washer (loading unit) 26. Further, a return spring 24 is disposed at the gear 23; the return spring 24 urges the rod 32 in the opposite direction to the rotational direction due to the driving force of the motor 11 to return the valve 37 to a closed position that is abutted against a valve seat 39 during the halt of the motor 11.

A through hole 31a for providing the communication between the outside and a gas passage (fluid passage) 38 is prepared at a valve section housing 31. The rod 32 is inserted into the through hole 31a. Moreover, a bush (bushing section) 35 is press-fitted into the through hole 31a and fixed with a fixing pin 34. The bush 35 serves as a bushing to pivotally support the rod 32 to be rotatable. Further, in the through hole 31a, a plate (shaft seal section) 36 is press-fitted on the outer peripheral surface of the rod 32, and the rod 32 and the plate 36 are rotated integrally with each other. Furthermore, a cover 33 is disposed between the valve section housing 31 and the gear section housing 21 to prevent carbon deposit, dust and the like contained in the gas from entering the gear section housing 21 along the outer peripheral surface of the rod 32.

Further, the valve 37 is fixed to the rod 32, and the valve 37 is rotated integrally with the rod 32 to abut against the valve seat 39 provided in the gas passage 38 to thereby stop the flow-through of the gas.

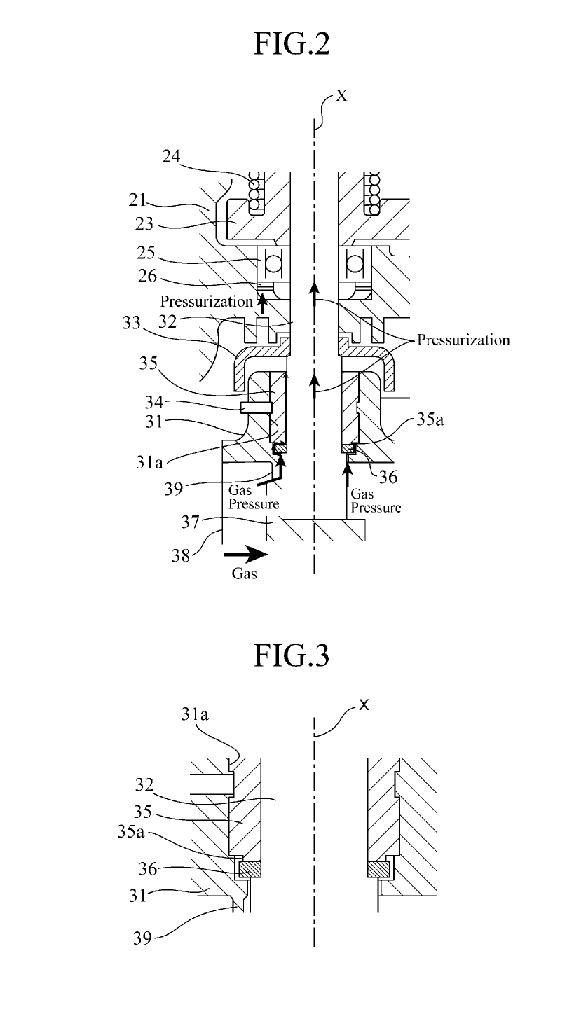

Next, the axial leakage reducing structure of the EGR valve will now be discussed with reference to enlarged sectional views of FIG. 2 and FIG. 3.

The gas flowing through the gas passage 38 and the gas leaking from the gap between the valve 37 and the valve seat 39 leak upwardly in the axial direction along the outer peripheral surface of the rod 32; however, since the plate 36 is press-fitted on the outer peripheral surface of the rod 32, no gap is given between the inner peripheral surface of the plate 36 and the outer peripheral surface of the rod 32, and also no axial leakage is caused from the corresponding part.

Moreover, the gas flowing through the gas passage 38 and the gas leaking from the gap between the valve 37 and the valve seat 39 pressurize the rod 32 with flowing upwardly in the axial direction along the outer peripheral surface thereof. By the pressurization acting on the rod 32, the plate 36 united with the rod 32 is abutted against the bush 35. In such a way, when the plate 36 is positively abutted against the bush 35 by the pressurization acting on the rod 32 to thus fill the gap between the abutment surfaces of the plate 36 and the bush 35, gas leaking passages can be eliminated, which enables to suppress the axial leakage.

In addition, the washer 26 places a load on the bearing 25, and the load also acts on the rod 32 by way of the bearing 25. The pressurization produced by the washer 26 works on the rod 32 together with the pressurization produced by the gas pressure to abut the plate 36 united with the rod 32 against the bush 35. Therefore, under gas pressure fluctuating conditions, for example, even in the case that the gas pressure becomes negative and the plate 36 is pulled in a direction to be separated from the bush 35, the axial leakage can be suppressed because the load of the washer 26 pressurizes the plate 36.

As described above, when the axial leakage reducing structure is arranged such that the plate 36 is press-fitted on the rod 32, and that also the plate 36 is abutted against the bush 35 by the pressurization acting on the rod 32 to create a labyrinth structure between the rod 32, the plate 36 and the bush 35, gas leaking passages can be eliminated to thereby reduce the amount of the axial leakage. Further, by the establishment of such a structure, the pressure of the gas works in a direction where the plate 36 and the bush 35 are made close contact with each other; thus, the structure can be applicable even under a high pressure. Moreover, the plate used for the formation of the labyrinth structure may be a single plate of the plate 36; thus, the number of components, the number of man-hours for the assembly, and the cost can be reduced, as compared to the case where a plurality of plates are used as in the conventional. Furthermore, by the pressurization on the rod 32, vertical vibrations in the axial direction of the rod 32 that is subjected to vibrations from an engine and so on or pressure pulsations in the gas passage 38, as well as the valve 37 and the plate 36 united with the rod 32 can be reduced. As a result, the wear of the abutment surfaces of the bush 35, and the rod 32 and plate 36, and of the abutment surfaces of the valve seat 39 and the valve 37 can be reduced.

Further, the material for the bush 35 and the plate 36 are selected according to the temperature condition of the gas to lower the axial leakage even under high temperatures of 200-800° C. A potential one of the material includes carbon, metal, ceramic, and the like; however, stainless steel is preferable for both of the bush 35 and the plate 36 under a high temperature gas condition, and carbon may also be used under a low temperature gas condition.

Moreover, the wear on the abutment surfaces of the bush 35 and the plate 36 is restrained in consideration of the combination of both materials of the bush 35 and the plate 36, the hardness, the coating, and the surface treatment thereof. For example, the reduction of the wear is contemplated as follows: a material having substantially the same or close hardness is selected for the bush 35 and the plate 36, and further the abutment surfaces of the bush 35 and the plate 36 are subjected to surface treatment such as nickel plating, nickel-chrome plating, or nitriding treatment.

Further, it is contemplated that the wear on the abutment surfaces is suppressed in consideration of the shapes of the bush and the plate in addition to the selection of the material and the surface treatment as discussed above. Assuming that the outer diameter of the bush 35 is larger than that of the plate 36, a shoulder is developed on the abutment surface of the bush 35 and the plate 36 as the wear of the bush 35 is advanced; thus, there is a concern such that the plate 36 easily sticks to the bush 35 upon rotation of the rod 32.

For this reason, the outer diameter at the lower end in the axial direction of the bush 35 is adapted to be smaller than that of the plate 36, so that a reduced-diameter end 35a is formed. In such a way, even when the plate 36 is rotated to the bush 35 to wear the abutment surfaces thereof, the wear is to be uniformly developed without the shoulder, which provides a structure such that the wear portions of the bush 35 and the plate 36 do not easily get stuck or caught.

Further, since the positioning of the valve 37 to the valve seat 39 is carried out not by pressing the valve 37 against the valve seat 39, but by pressing the plate 36 united with the rod 32 against the bush 35, a distance of the rod 32 from the valve 37 to the abutment position of the bush 35 and the plate 36 is relatively short; thus,

even if thermal expansion makes dimensional changes in the members during the flow-through of a high temperature gas, the effects caused by the changes can be reduced. Particularly, even in the event that the valve 37 is expanded due to the thermal expansion, the valve seat leakage can be suppressed.

As discussed above, according to the first embodiment, the EGR valve is configured to include: the valve section housing 31 in which the through hole 31a communicating with the fluid passage 38 provided inside is formed; the rod 32 inserted into the gas passage 38 through the hole 31a to be rotated about the central axis of rotation X; the valve 37 to be rotated integrally with the rod 32 to open and close the valve seat 39 of the gas passage 38; the bush 35 provided inside the through hole 31a to pivotally support the rod 32 to be rotatable; and the plate 36 press-fitted on the outer peripheral surface of the rod 32 to be rotated with abutting against the surface of the bush 35 on the side of the gas passage 38 by the pressurization acting on the rod 32. For this reason, the gap between the abutment surfaces of the rod 32 and the plate 36 is eliminated by the press-fitting, and further when the bush 35 is abutted against the plate 36 by the pressurization acting on the rod 32, gas leaking routes are established by a labyrinth structure constructed of the rod 32, the bush 35, and the plate 36, which enables to reduce the axial leakage from the gap between the rod 32 and the bush 35.

Further, according to the first embodiment, since it is configured such that the pressurization working on the rod 32 is produced by the pressure of the gas flowing out from the gas passage 38 through the through hole 31a, the bush 35 and the plate 36 can be positively abutted against each other to fill the gap therebetween, and thereby the axial leakage can be reduced. Moreover, since the pressure of the gas works in the direction where the plate 36 is come into close contact with the bush 35, the sealing force can be further increased under a high pressure to reduce the axial leakage more effectively. Furthermore, the vibrations of the rod 32 in the axial direction caused by the vibrations of an engine or the like or the pressure pulsations of gases can be suppressed; as a result, the wear of the bush 35, the plate 36, and the rod 32 can be suppressed.

Moreover, according to the first embodiment, since it is configured that the EGR valve include the washer 26 for loading the rod 32 in the direction to the central axis of rotation X by loading the bearing 25, so that the pressurization acting on the rod 32 is produced by the washer 26, the bush 35 and the plate 36 can be positively abutted against each other to fill the gap therebetween, and even when the gas pressure is fluctuated, the axial leakage can be reduced. Furthermore, the vibrations of the rod 32 in the axial direction caused by the vibrations of an engine or the like or by the pressure pulsations of the gas can be suppressed; as a result, the wear of the bush 35, the plate 36, and the rod 32 can be suppressed.

According to the first embodiment, further, when the material according to the temperature of the gas is employed for the bush 35 and the plate 36, the structure is applicable under gas temperature conditions of 200-800° C. to which PTFE and so on are unusable, so that the axial leakage can be reduced under high temperature conditions.

Furthermore, according to the first embodiment, when a material having substantially the same hardness is employed for the bush 35 and the plate 36, and/or the abutment surfaces each are subjected to the surface treatment, the wear on the abutment surfaces can be suppressed. Besides, when the outer diameter at the end face of the bush 35 to be abutted against the plate 36 is provided by the reduced-diameter end 35a smaller than that of the plate 36, assuming that the abutment surfaces are wear, the structure can be performed not easily get stuck and caught.

Additionally, according to the first embodiment, since the bush 35 and the plate 36 are abutted against each other to thereby position the valve 37, the positioning members, namely the bush 35 and the plate 36, are positioned near to the valve 37, thereby lowering the effects of the dimensional changes caused by the thermal expansion under high temperatures.

### INDUSTRIAL APPLICABILITY

As described above, since the axial leakage reducing structure according to the present invention can reduce the axial leakage even under high temperature and high pressure conditions, it is suitable for use in EGR valves and so on.

1. An axial leakage reducing structure for a valve comprising:
a housing in which a through hole communicating with a fluid passage provided inside is formed;
a valve shaft inserted into the fluid passage through the through hole to be rotated about a central axis of rotation;
a valve body to be rotated integrally with the valve shaft to open and close the fluid passage;
a bushing section provided inside the through hole to pivotally support the valve shaft to be rotatable; and
a shaft seal section press-fitted on the outer peripheral surface of the valve shaft to be rotated with abutting against the surface of the bushing section on the side of the fluid passage by pressurization acting on the valve shaft.

2. The axial leakage reducing structure for a valve according to claim 1, wherein the pressurization is produced by the pressure of fluid flowing from the fluid passage through the through hole.

3. The axial leakage reducing structure for a valve according to claim 1, further comprising: a loading unit for loading the valve shaft in a direction of the central axis of rotation, wherein the pressurization is produced by the load of the loading unit.

4. The axial leakage reducing structure for a valve according to claim 1, wherein a material according to the temperature of a fluid is used for the bushing section and the shaft seal section.

5. The axial leakage reducing structure for a valve according to claim 1, wherein a material having substantially the same hardness is used for the bushing section and the shaft seal section.

6. The axial leakage reducing structure for a valve according to claim 1, wherein the abutment surfaces of the bushing section and the shaft seal section each are subjected to surface treatment.

7. The axial leakage reducing structure for a valve according to claim 1, wherein the outer diameter at the end face of the bushing section abutting against the shaft seal section is provided smaller than that of the shaft seal section.

8. The axial leakage reducing structure for a valve according to claim 1, wherein the valve body is positioned by the abutment of the bushing section and the shaft seal section.
